(19) United States
(12) Patent Application Publication
(10) Pub. No.: US 2026/0208610 A1
(43) Pub. Date: Jul. 23, 2026

(54) DC-CHARGING SYSTEM

(71) Applicant: EPIROC ROCK DRILLS AKTIEBOLAG, Örebro (SE)

(72) Inventors: Jian ZHAO, Örebro (SE); Trent SEARS, Örebro (SE)

(21) Appl. No.: 19/142,159

(22) PCT Filed: Dec. 22, 2022
(86) PCT No.: PCT/SE2022/051235

§ 371 Date: Jun. 20, 2025

(51) Int. Cl. B60L 53/53; B60L 53/16; B60L 53/302

(52) U.S. Cl. CPC B60L 53/53; B60L 53/16; B60L 53/302; B60L 2200/40

(57) ABSTRACT

Disclosed is a DC-charging system arranged for charging a battery for an electrically powered mining, constructions, or excavation vehicle. The system includes one or more power units and one or more charger units Each power unit is arranged for receiving power from an external source and for transferring transformed power to at least one charger unit. Each charger unit is arranged for receiving transformed power from at least one power unit and transfer charging power to a battery for an electrically powered mining, constructions or excavation. Each power unit includes at least one first mating side and each charger unit comprises at least one second mating side, which are arranged to mate/fit to each other such that, when positioned side by side, the at least one power unit and the at least one charger unit form a single, spatially confined unit.

### TECHNICAL FIELD

The present disclosure relates generally to a DC-charging system.

### BACKGROUND

DC-charging systems are used for charging different kinds of machines and tools operating with an electrical driveline, i.e., for charging batteries of such machines and tools, which are used for example within mining industry. Known charging systems used for mining industry normally comprises a complete DC charger within the same enclosure/housing. The background art DC-charger thus comprises electrical inputs, a transformer, a switch box, one or more power modules, one or more splitters for directing power, e.g., to more than one vehicle, a control unit, and electrical outputs.

Demands within mining industry, concerning e.g., input voltage, input power, output power, sealing (IP-class rating), vary between different markets, and known DC-chargers are designed to fit the end-market needs. As a result, chargers are provided in a multitude of physical sizes adapted to the respective need and application, for example one housing covering up to a certain range of input voltage and power and output power, and a next size of housing covers a next part of a range and so on.

Within mining industry, DC-chargers may be used at charging hubs located at different positions in the mine, where a vehicle may be charged by being connected to the DC-charger or may be ready for work by changing to a charged battery, which is charged at the hub by a DC-charger. During development of a mine, the charging needs vary over time, for example due to variation of the number of vehicles and the types of vehicles employed in the work environment. Prior art solutions provide hubs which are not easy to scale in a simple manner and instead provide quite bulky complete DC-chargers which are not easily adaptable to the shifting charging needs in the mine. Yet another problem with existing DC-chargers is that for larger charging needs, e.g., requirements for higher power/effect, the high-power charger will be large and bulky which is not convenient in a mine. For example, due to the size, such bulky DC-chargers can only be transported by large vehicles along a road down in the mine instead of being transported via an elevator, which may be very time-consuming and impractical compared to transport via an elevator.

Thus, there is a need for an improved DC-charging system which takes care of the above problems.

### SUMMARY

It is an object of the disclosure to address at least some of the problems and issues outlined above. An object of aspects of the present disclosure is to provide a modular DC-charging system. The system is easy to scale up and scale down and every single unit is designed to be easy transported as well as connected to other units to scale the system depending on the demands at the local site and during progress of the mine.

According to one aspect, a DC-charging system which is arranged for charging a battery for an electrically powered mining, constructions, or excavation vehicle, is disclosed. The DC-charging system comprising one or more power units and one or more charger. Each power unit comprises a first electrical input connector, a power transformer and a first electrical output connector and is arranged for receiving power from an external source via the first electrical input connector, and for transferring transformed power to at least one charger unit via the first electrical output connector. The transformed power is of course transformed by the transformer and depending on the type of input power and output power demand, the transition may be any of AC to AC, AC to DC or DC to DC. Each charger unit comprises a second electrical input connector, at least one power module, at least one power distributing module, at least one control unit and a second electrical output connector, wherein each charger unit is arranged for receiving transformed power from at least one power unit via the second electrical input connector and transfer charging power to a battery for an electrically powered mining, constructions or excavation vehicle via the second electrical output connector. As mentioned above, the modular DC-charging system is easy to scale up and scale down by combining an optional number of power units and an optional number of charger units, wherein each power unit comprises at least one first mating side and each charger unit comprises at least one second mating side, which first and second mating sides are arranged to mate/fit to each other such that, when positioned side by side, the at least one power unit and the at least one charger unit form a single, spatially confined unit.

By such a modular DC-charging system, it is possible to adapt the charger system with a great amount of freedom regarding the number of power units and charger units, the equipment in each unit (for example number of power modules, power distributing modules, control units, input/output connector per charger unit) and the combinations of them as well as the electrical connection of the power and charger units in the system (series, parallel, star type, daisy chain). By the inventive modular concept of the DC-charger system, the shifting demands within mining industry, concerning different needs of input voltage, input power, output power, sealing (IP-class rating), is taken care of by the modular design, where prior art instead provide chargers in a multitude of different physical sizes adapted to the respective need and application, which means bulky DC-charging boxes which are difficult to transport and hard to scale up and down in a cost-efficient and easy way.

According to a disclosure, the at least one first mating side of each power unit and the at least one second mating side of each charger unit are equal in size. This means that they are possible to arrange side-by-side with at least one other power unit/charger unit and also possible to physically connect the units to form a single, spatially confined unit where the units mate to each other in a good way.

According to a disclosure, each power unit comprises two first mating sides arranged opposite each other, wherein a size of each first mating side is defined by a first height and a first depth, wherein a first width of the power unit is defined as a distance between the two opposite first mating sides, and wherein the first width is smaller than the first height and is smaller than the first depth. By this design, the power unit have at least two mating sides, wherein the power unit can mate to at least two other units (power unit or charger unit), one on each side and the power unit has a “sliced” designed since the width is narrower than the height and the depth, preferably a width which is about half the height/depth. This provides a power module which is possible to transport both along mine passages by a vehicle and also by elevators in vertical mine shafts and combine with other units at the site where a DC-charging system is to be setup, for charging vehicles and/or tools down in the mine, in an easy, modular, and scalable way. Prior art solutions do not provide this possibilities.

According to a disclosure, each charger unit comprises two second mating sides arranged opposite each other, wherein a size of each second mating side is defined by a second height and a second depth, wherein a second width of the charger unit is defined as a distance between the two opposite second mating sides, and wherein the second width is smaller than the second height and is smaller than the second depth. By this design, the charger unit have at least two mating sides, wherein the charger unit can mate to at least two other units (power unit or charger unit), one on each side and the charger unit has a “sliced” design with the benefits explained above in relation to the power unit.

According to a disclosure, each power unit comprises at least one first mechanical connector means arranged at the at least one first mating side and each charger unit comprises at least one second mechanical connector means arranged at the at least one second mating side, which first and second mechanical connector means are arranged for mechanically connecting at least one power unit and at least one charger unit to each other, when positioned side by side. The connection means may preferably be arranged at all mating sides of each unit (power units and charger units) and at positions which are out of the way for the “mating areas” such that the units may abut each other when arranged side-by-side and connected. The connection means may be arranged in many different ways, like for example being arranged to connect the units with screw and bolt, clamps, toggle latches, container/cargo couplers, tube connectors or the like.

According to a disclosure, each power unit comprises a cooling unit, which is arranged to cool the power unit, and each charger unit comprises a cooling unit, which is arranged to cool the charger unit, wherein each cooling unit is arranged at any side of the power unit or charging unit which is not configured as a first or second mating side. This means that the cooling unit never will interfere with the mating sides of the units and by that, the power unit/units and charger unit/units can be positioned side-by-side and connected to each other without considering the position of the cooling unit. The cooling unit of the power unit may comprise cooling means (for example pipes/tubes) which enters the power unit in a sealed manner such that the cooling unit is sealed from the power unit, and the cooling unit of the charger unit may comprise cooling means which enters the charger unit in a sealed manner such that the cooling unit is sealed from the charger unit. Preferably, the IP-classification of the units fulfils the demands of IP 61 up to IP 67.

According to a disclosure, each power unit and each charger unit comprises forklift pockets. By that, each unit is easy to transport by a forklift which is a convenient solution within the mine industry.

According to a disclosure, each power unit and each charger unit comprises lifting hooks. By that, each unit is easy to transport by a different kinds of lifting arrangements.

According to a disclosure, the first electrical output connector of the power unit comprises a quick connector and the second electrical input connector of the charger unit comprises a quick connector, wherein the quick connector of the power unit and the quick connector of the charger unit are arranged to connect to each other. In fact, all electrical connections (input/output) arranged to connect to power supply, other units or batteries may be of quick connector type.

According to a disclosure, the system further comprises at least one energy storing unit arranged for storing energy. The stored energy may be used for charging a battery of an electrically powered mining, constructions, or excavation vehicle or other electrically powered equipment. The energy storing unit comprises a third electrical input connector, at least one battery module and a third electrical output connector. The energy storing unit is arranged for receiving power from the charger unit via the third electrical input connector and arranged for storing the power in the at least one battery module, and further arranged for transferring the stored power to a battery for an electrically powered mining, constructions, or excavation vehicle, via the third electrical output connector. Each energy storing unit comprises at least one third mating side, which third mating side is arranged to mate to a mating side of at least one charger unit, such that, when positioned side by side, the at least one energy storing unit and the at least one charger unit form a single, spatially confined unit. The energy storing unit may comprise similar features like the features of the power unit and charger unit, that is two opposite mating sides, sliced design, mechanical connector means, cooling unit, forklift pockets, lifting hooks, electrical input and output connectors.

According to a disclosure, the energy storing unit comprises a plurality of battery modules which forms a battery sub-pack.

According to a disclosure, the energy storing unit comprises a plurality of battery sub-packs which forms a battery pack. The battery pack may be one or more battery packs, wherein each battery pack may be removably arranged in the energy storing unit such that a battery pack of an electrically powered mining, constructions, or excavation vehicle, or any other electrically powered equipment, may be shifted/replaced with a charged battery pack from the energy storing unit.

Some advantages with using a sub-packs and battery packs is that the system is modular. The battery sub-pack is intended to be used as a core battery system for an electric vehicle fleet. Different electric vehicles and other equipment uses different battery packs that contains different number of sub-packs. With the system, it is possible to use new or used (second life) battery sub-packs (or other battery system) for forming a battery pack which is used as an energy storing unit. For example, battery sub-packs or complete battery packs which not longer fulfil requirements to be used as the power source of an electrically powered vehicle, may be good enough to use for energy storing in the energy storing unit.

Further possible features and benefits of this solution will become apparent from the detailed description below.

### BRIEF DESCRIPTION OF DRAWINGS

The invention is now described, by way of example, with reference to the accompanying drawings, in which:

FIG. 1a shows a perspective view of a front side and a first mating side of a power unit of the inventive DC-charger system.

FIG. 1b shows a perspective view of a back side and an, relative the first mating side of FIG. 1a, opposite first mating side, of the power unit of FIG. 1a.

FIG. 1c shows a section view along the power unit.

FIG. 2a shows a perspective view of a front side and a second mating side of a charger unit of the inventive DC-charger system. The charger unit has similar back and front sides why FIG. 2a also may symbolize the back side and opposite second mating side of the charger unit.

FIG. 2b shows a section view along the charger unit.

FIG. 3a shows a perspective view of a front side and a second mating side of an energy storing unit of the inventive DC-charger system. The energy storing has similar back and front sides why FIG. 3a also may symbolize the back side and opposite second mating side of the charger unit.

FIG. 3b shows a section view along the energy storing unit.

FIG. 4a shows a perspective view of the power unit of FIG. 1a and the charger unit of FIG. 2a, when positioned side-by-side and ready to be brought together and mechanically connected to each other.

FIG. 4b shows a perspective view of the power unit and the charger unit of FIG. 4a, when being brought together and mechanically connected to each other, to form a single, spatially confined unit.

FIG. 5a shows a perspective view of two power units and three charger units, when positioned side-by-side and ready to be brought together and mechanically connected to each other. As an option, one of the units may be an energy storing unit.

FIG. 5b shows a perspective view of two power units and three charger units, when being brought together and mechanically connected to each other, to form a single, spatially confined unit. As an option, one of the units may be an energy storing unit.

### DETAILED DESCRIPTION

In the following, different examples of a DC-charging system according to the present disclosure are described. The DC charging system disclosed herein may be realized in many different forms and should not be construed as being limited to the examples set forth herein. Like numbers in the drawings refer to like elements throughout.

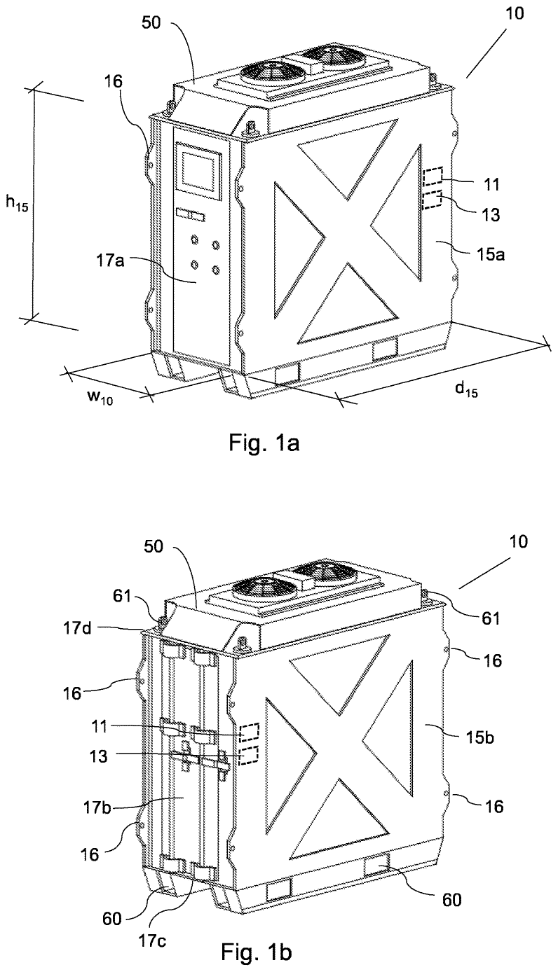

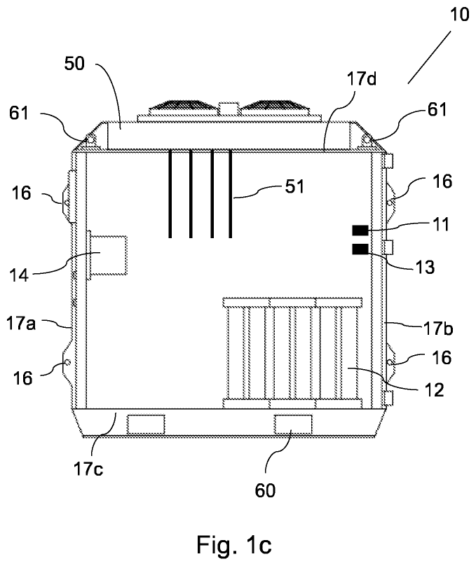

FIGS. 1a-b shows perspective views of a power unit 10 of the inventive DC-charger system. The power unit 10 comprises two first mating sides 15a, 15b, arranged opposite each other, wherein a size of each first mating side 15a, 15b is defined by a first height h₁₅ and a first depth d₁₅. A first width w₁₀ of the power unit 10 is defined as a distance between the two opposite first mating sides 15a, 15b, and the first width w₁₀ is smaller than the first height h₁₅ and is smaller than the first depth d₁₅. By that, the power unit 10 is narrow and preferably, the first width w₁₀ does not exceed half the first height h₁₅ or half the first depth d₁₅. The design of the power unit 10 has a box-like design with a front side 17a and an opposite back side 17b which respective size (area) is defined by the width w₁₀ and the first height h₁₅. The front side 17a comprises a door, an HMI panel, control lamps and control buttons and a main disconnect handle. The power unit 10 further comprises a bottom side 17c and an opposite top side 17d which respective size (area) is defined by the width w₁₀ and the first depth d₁₅. Each power unit 10 further comprises a plurality of first mechanical connector means 16, arranged at each first mating sides 15a, 15b, preferably four first mechanical connector means 16 per first mating sides 15a, 15b. The first mechanical connector means 16 are arranged for mechanically connecting the power unit 10 with a charger unit 20 and/or another power unit 10, when positioned side by side, wherein each power unit 10 may be mechanically connected to two other units 10, 20, one on each first mating side 15a, 15b. On the top side 17d of the power unit 10 is a cooling unit 50 arranged. This is arranged to cool the power unit 10, and the cooling unit 50 is arranged at any side of the power unit 10, which is not configured as a first mating side 15a, 15b, and the preferred position is as said, on the top side 17d of the power unit 10. The power unit 10 comprises forklift pockets 60 arranged at a bottom frame part arranged at the bottom side 17c. The forklift pockets are arranged such that the power unit 10 may be lifted by a forklift in direction from the mating sides 15a, 15b or in direction from the front side 17a or back side 17b. The power unit further comprises lifting hooks 61, which are arranged on the top side 17d. The lifting hooks 61 are arranged such that the power unit 10 may be lifted by ropes, chains, straps or the like. By the forklift pockets 60 and the lifting hooks 61, it is easy to move the power unit in an easy way. The back side 17b comprises a door and locks such that the interior is easy to reach from the back side 17b, which door and locks are visible in FIG. 1b.

FIG. 1c shows a section view along the power unit 10 of FIGS. 1a-b, that is, along the depth-direction of the power unit 10. The power unit 10 comprises a first electrical input connector 11, a power transformer 12 and a first electrical output connector 13, and the power unit 10 is arranged for receiving power from an external source via the first electrical input connector 11, transform the input power in the power transformer 12 and transferring the transformed power to a charger unit 20 (or another power unit depending on the electrical connection setup of the DC-charger system) via the first electrical output connector 13. The electrical input/output connectors may be arranged at the mating sides of the unit. The cooling unit comprises cooling means 51 which enters the power unit 10 in a sealed manner such that the cooling unit 50 is sealed from the power unit 10 to fulfil high IP-classification, preferably in the range of IP 61-67. The cooling means 51 of FIG. 1c is shown symbolically as a plurality of pipes or colling flanges protruding from the cooling unit 50 and into the power unit 10. The cooling unit 50 comprises fans, electrical connections and other equipment needed for a complete colling unit to cool the power unit 10, and the cooling units 50 of the DC-charging system preferably are standardized with a similar or identical design independently of the unit it is arranged on top of (power unit, charger unit, energy storing unit).

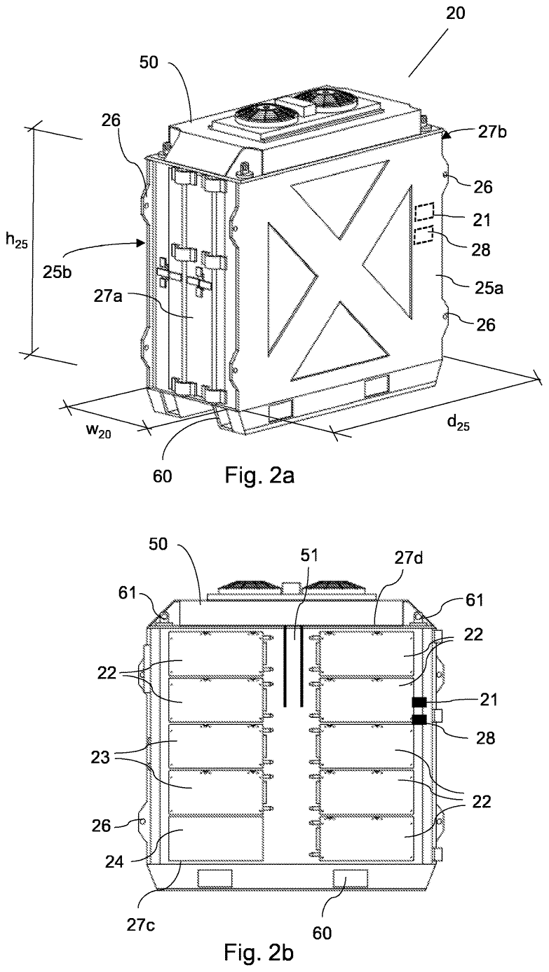

FIG. 2a shows a perspective view of a charger unit 20 of the inventive DC-charger system. The charger unit 20 comprises two second mating sides 25a, 25b, arranged opposite each other, wherein a size of each second mating side 25a, 25b is defined by a second height h₂₅ and a second depth d₂₅. A second width w₂₀ of the charger unit 20 is defined as a distance between the two opposite second mating sides 25a, 25b, and the second width w₂₀ is smaller than the second height h₂₅ and is smaller than the second depth d₂₅. By that, the charger unit 20 is narrow and preferably, the second width w₂₀ does not exceed half the second height h₂₅ or half the second height h₂₅. Thus, the design of the charger unit 20 is more or less similar with the design of the power unit 10 and has the box-like design with a front side 27a and an opposite back side 27b which respective size (area) is defined by the second width w₂₀ and the second height h₂₅. The front side 27a comprises a door, locks, and maneuver handles such that the interior is easy to reach from the front side 27a. The charger unit 20 further comprises a bottom side 27c and an opposite top side 27d which respective size (area) is defined by the second width w₂₀ and the second depth d₂₅. The charger unit 20 has similar front and back sides 27a, 27b, wherein also the back side 27b comprises a door and locks such that the interior is easy to reach from the back side 27b. Each charger unit 20 further comprises a plurality of second mechanical connector means 26, arranged at each second mating sides 25a, 25b, preferably four second mechanical connector means 26 per second mating sides 25a, 25b. The second mechanical connector means 26 are arranged for mechanically connecting the charger unit 20 with a power unit 10 and/or another charger unit 20, when positioned side by side, wherein each charger unit 20 may be mechanically connected to two other units 10, 20, one on each second mating side 25a, 25b. On the top side 27d of the charger unit 20 is a cooling unit 50 arranged. This is arranged to cool the charger unit 20, and the cooling unit 50 is arranged at any side of the charger unit 20, which is not configured as a second mating side 25a, 25b, and the preferred position is as said, on the top side 27d of the charger unit 20. The charger unit 20 comprises forklift pockets 60 and lifting hooks 61, arranged in the same way as for the power unit 10, that is to follow the modular concept of the DC-charger system.

FIG. 2b shows a section view along the charger unit 20 of FIG. 2a, that is, along the depth-direction of the charger unit 20. The charger unit 20 comprises a second electrical input connector 21, a plurality of power modules 22 (seven in the exemplified embodiment), two power distributing module 23, one control unit 24 and a second electrical output connector 28. The charger unit 20 is arranged for receiving transformed power from at least one power unit 10 via the second electrical input connector 21 and transfer charging power to a battery for an electrically powered mining, constructions or excavation vehicle via the second electrical output connector 28. The electrical input/output connectors may be arranged at the mating sides of the unit. In the shown disclosure of the charger unit 20, the charger unit 20 is equipped with seven power modules 22, two power distributing modules 23 and one control unit 24. The control unit 24 is “the brain” controlling the function of the power modules 22 and the power distributing modules 2, for example how to split and direct power depending on the input power and output charging power of the application site and the charging need at the time for charging. For example, input voltage options may be 400V, 600V, 1000V, 4.16 kV, 11 kV, 13.8 kV, up to 25 kV, input power options may be 250 KVA, 500 kVA, up to 1200 kVA, and the output charging power may be 2000 KW, 350 KW, up to 1 MW. As an example, each power module 22 provides certain level of output power, i.e. 50 KW and with four power modules 22 in one charger unit 20, the charger unit 20 will provide 200 kW charging power. With more power modules 22, or multiple power units 10, connected together, the output charging power could reach up to 1 MW. The cooling unit 50 comprises cooling means 51 which enters the charger unit 20 in a sealed manner such that the cooling unit 50 is sealed from the charger unit 20 to fulfil high IP-classification, preferably in the range of IP 61-67. The cooling means 51 of FIG. 2b is shown symbolically as a plurality of pipes or colling flanges protruding from the cooling unit 50 and into the charger unit 20. The cooling unit 50 comprises fans, electrical connections and other equipment needed for a complete colling unit to cool the charger unit 20.

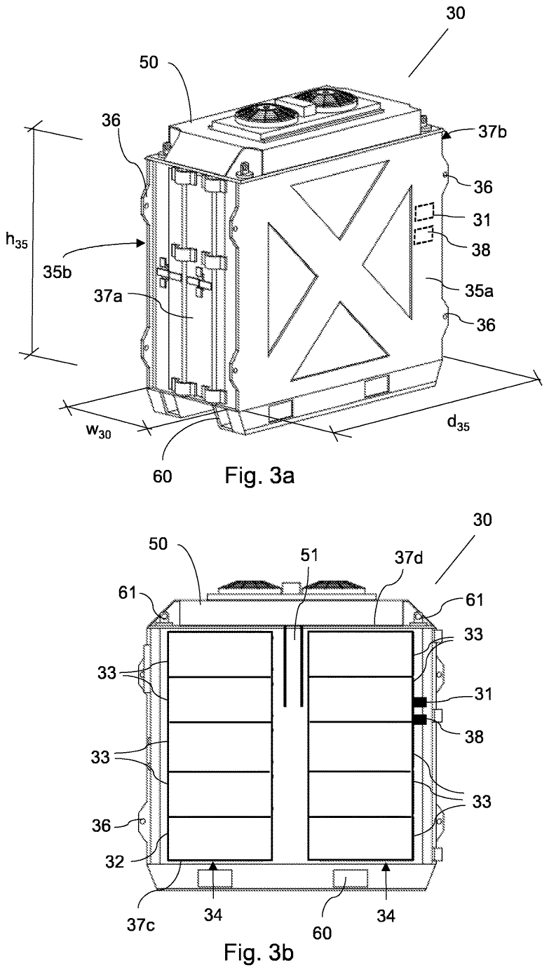

FIG. 3a shows a perspective view of an energy storing unit 30 of the inventive DC-charger system. The energy storing unit 30 comprises two third mating sides 35a, 35b, arranged opposite each other, wherein a size of each third mating side 35a, 35b is defined by a third height h₃₅ and a third depth d₃₅. A third width w₃₀ of the energy storing unit 30 is defined as a distance between the two opposite third mating sides 35a, 35b, and the third width w₃₀ is smaller than the third height h₃₅ and is smaller than the third depth d₃₅. By that, the energy storing unit 30 is narrow and preferably, the third width w₃₀ does not exceed half the third height h₃₅ or half the third height h₃₅. Thus, the design of the energy storing unit 30 is more or less similar with the design of the power unit 10 and the charger unit 20 and has the box-like design with a front side 37a and an opposite back side 37b which respective size (area) is defined by the third width w₃₀ and the third height h₃₅. The front side 37a comprises a door, locks, and maneuver handles such that the interior is easy to reach from the front side 37a. The energy storing unit 30 further comprises a bottom side 37c and an opposite top side 37d which respective size (area) is defined by the third width w₃₀ and the third depth d₃₅. The energy storing unit 30 has similar front and back sides 37a, 37b, wherein also the back side 37b comprises a door and locks such that the interior is easy to reach from the back side 37b. Each energy storing unit 30 further comprises a plurality of third mechanical connector means 36, arranged at each third mating sides 35a, 35b, preferably four third mechanical connector means 36 per third mating sides 35a, 35b. The third mechanical connector means 36 are arranged for mechanically connecting the energy storing unit 30 with the charger unit 20 and/or another energy storing unit 30, when positioned side by side, wherein each energy storing unit 30 may be mechanically connected to two other units 20, 30, one on each third mating side 35a, 35b. On the top side 37d of the energy storing unit 30 is a cooling unit 50 arranged. This is arranged to cool the energy storing unit 30, and the cooling unit 50 is arranged at any side of the energy storing unit 30, which is not configured as a third mating side 35a, 35b, and the preferred position is as said, on the top side 37d of the energy storing unit 30. The energy storing unit 30 comprises forklift pockets 60 and lifting hooks 61, arranged in the same way as for the power unit 10 and charger units 20, that is to follow the modular concept of the DC-charger system.

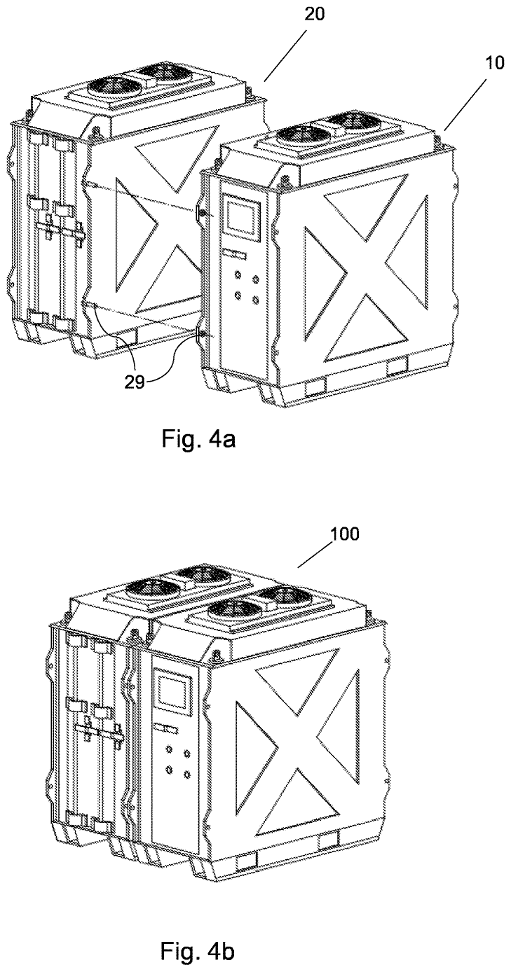

FIG. 3b shows a section view along the energy storing unit 30 of FIG. 3a, that is, along the depth-direction of the energy storing unit 30. The energy storing unit 30 comprises a third electrical input connector 31, at least one battery module 32 and a third electrical output connector 38. The electrical input/output connectors may be arranged at the mating sides of the unit. The energy storing unit 30 is arranged for receiving power from the charger unit 20 via the third electrical input connector 31 and is further arranged for storing the power in the at least one battery module 32. The energy storing unit 30 is further arranged for transferring the stored power to a battery for an electrically powered mining, constructions, or excavation vehicle, via the third electrical output connector 38. The energy storing unit 30 has the same modular design as the power unit 10 and charger unit 20, and comprises two third mating side 35a, 35b, which are arranged to mate to a mating side of at least one charger unit 20, such that, when positioned side by side, the at least one energy storing unit 30 and the at least one charger unit 20 form a single, spatially confined unit 100 (see further FIGS. 4a-b and 5a-b). The modular concept is further designed such that the energy storing unit 30 comprises a plurality of battery modules 32, which together forms a battery sub-pack 33. Further, a plurality of battery sub-packs 33 forms a battery pack 34. The battery sub-pack 33 is used as a core battery system for an electric vehicle fleet. Different electric vehicles and other equipment uses different battery packs 34, that contains different number of battery sub-packs 33. With the system, it is possible to use new or used (second life) battery sub-packs (or other battery system) for forming a battery pack 34, which is used as the energy storing unit 30. For example, battery sub-packs 33 or complete battery packs 34, which no longer fulfil requirements to be used as the power source of an electrically powered vehicle, may be good enough to use for energy storing in the energy storing unit 30.

FIG. 4a shows a perspective view of the power unit 10 of FIG. 1a and the charger unit 20 of FIG. 2a, when positioned side-by-side and ready to be brought together and mechanically connected to each other. FIG. 4b shows a perspective view of the power unit 10 and the charger unit 20 of FIG. 4a, when being brought together and mechanically connected to each other, to form a single, spatially confined unit 100. The units 10, 20 preferably are mechanically connected to each other with attaching means 29, such as screw and bolt, clamps, toggle latches, container/cargo couplers, tube connectors or the like. The DC-charging system has as mentioned above, a “sliced design”, which means that it must comprise at least one power unit 10 together with one charger unit 20. In the preferred disclosure, the charger unit 20 comprises at least four power modules 22, wherein each power module 22 of the charger unit 20 provides an output power of 50 kW. With four power modules 22 in one charger unit 20, wherein the charger unit is electrically connected to one power module 10, the DC-charging system will provide 200 kW charging power from the charger unit 20, to a battery for an electrically powered mining, constructions or excavation vehicle via the second electrical output connector 28.

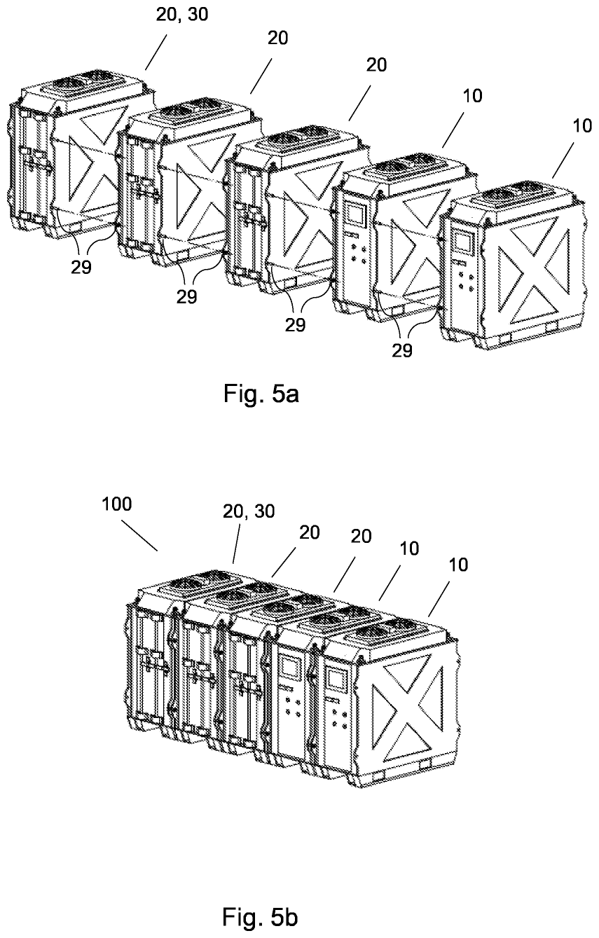

FIG. 5a shows a perspective view of two power units 10 and three charger units 20, when positioned side-by-side and ready to be brought together and mechanically connected to each other. As an option, one or more of the units may be an energy storing unit 30. FIG. 5b shows a perspective view of two power units 10 and three charger units 20, when being brought together and mechanically connected to each other, to form a single, spatially confined unit 100. As an option, one or more of the units may be an energy storing unit 30, which together with the other units 10, 20, 30 form the single, spatially confined unit 100. If an energy storing unit 30 is used, the charging power from the charger unit 20 is send to the energy storing unit 30 or if wanted, to a battery for an electrically powered mining, constructions or excavation vehicle, via the second electrical output connector 28.

By the modular and scalable DC-charging system, it is possible to adapt the charger system with a great amount of freedom regarding the number of power units 10 and charger units 20 (and optionally energy storing units 30), and the equipment in each unit (as explained above) and the combinations of them as well as the electrical connection of the power and charger units 10, 20 in the system (series, parallel, star type, daisy chain). By the inventive modular concept of the DC-charger system, the shifting demands within mining industry, concerning different needs of input voltage, input power, output power, sealing (IP-class rating), is taken care of by the modular design. The modular design of the power unit 10, the charger unit 20 enables that the first mating sides 15a, 15b of each power unit 10 and the second mating sides 25a, 25b of each charger unit 20 are equal in size, wherein the units 10, 20 are arranged to mate or fit to each other such that, when positioned side by side, the at least one power unit 10 and the at least one charger unit 20 form a single, spatially confined unit 100. The same modular thinking is also at hand when the energy storing unit 30 is a part of the system.

In the modular concept of the DC-charging system, electrical connections of the power unit 10, charger unit 20 and energy storing unit 30 may be of quick connection type. That means that at least the first electrical output connector 13 of the power unit 10 may comprise a quick connector and the second electrical input connector 21 of the charger unit 20 may comprise a quick connector arranged to be interconnected. In some examples, the quick connector of the power unit 10 and the quick connector of the charger unit 20 are arranged to connect to each other when mated and mechanically connected. In a similar way, the connections between charger units 20 and energy storing units 30 are at hand. Preferably all input/output connectors 11, 13, 21, 28, 31, 38 of the units 10, 20, 30 are of quick connection type.

In FIGS. 4a-b and 5a-b, all units 10, 20, 30 are arranged side-by-side and also connected to each other mechanically, which is the preferred way of arranging the units, since one by that can form one single and space-saving unit, but it is not necessary to put them side-by-side and connect them mechanically.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the figures, a broken line generally signifies that the feature within the broken line is optional.

1. A DC-charging system arranged for charging a battery for an electrically powered mining, constructions, or excavation vehicle, the DC-charging system comprising one or more power units and one or more charger units, wherein each power unit comprises a first electrical input connector, a power transformer and a first electrical output connector, wherein at least one power unit is arranged for receiving power from an external source via the first electrical input connector and for transferring transformed power to at least one charger unit via the first electrical output connector, wherein each charger unit comprises a second electrical input connector, at least one power module, at least one power distributing module, at least one control unit and a second electrical output connector, wherein at least one charger unit is arranged for receiving transformed power from at least one power unit via the second electrical input connector and transfer charging power to a battery for an electrically powered mining, constructions or excavation vehicle via the second electrical output connector, wherein each power unit comprises at least one first mating side and each charger unit comprises at least one second mating side, which first and second mating sides are arranged to mate/fit to each other such that, when positioned side by side, the at least one power unit and the at least one charger unit form a single, spatially confined unit.

2. The DC-charging system according to claim 1, the at least one first mating side of each power unit and the at least one second mating side of each charger unit are equal in size.

3. The DC-charging system according to claim 1, wherein each power unit comprises two first mating sides arranged opposite each other, wherein a size of each first mating side is defined by a first height and a first depth, wherein a first width of the power unit is defined as a distance between the two opposite first mating sides, and wherein the first width is smaller than the first height and is smaller than the first depth

4. The DC-charging system according to claim 1, wherein each charger unit comprises two second mating sides arranged opposite each other, wherein a size of each second mating side is defined by a second height and a second depth, wherein a second width of the charger unit is defined as a distance between the two opposite second mating sides, and wherein the second width is smaller than the second height and is smaller than the second depth.

5. The DC-charging system according to claim 1, wherein each power unit comprises at least one first mechanical connector means arranged at the at least one first mating side, and each charger unit comprises at least one second mechanical connector means arranged at the at least one second mating side, which first and second mechanical connector means are arranged for mechanically connecting at least one power unit and at least one charger unit to each other, when positioned side by side.

6. The DC-charging system according to claim 1, wherein each power unit comprises a cooling unit, which is arranged to cool the power unit, and each charger unit comprises a cooling unit which is arranged to cool the charger unit, wherein each cooling unit is arranged at any side of the power unit or charging unit which is not configured as a first or second mating side.

7. The DC-charging system according to claim 1, wherein each power unit and each charger unit comprises forklift pockets.

8. The DC-charging system according to claim 1, wherein each power unit and each charger unit comprises lifting hooks.

9. The DC-charging system according to claim 1, wherein the first electrical output connector of the power unit comprises a quick connector and the second electrical input connector of the charger unit comprises a quick connector, wherein the quick connector of the power unit and the quick connector of the charger unit are arranged to connect to each other.

10. The DC-charging system according to claim 1, wherein the system further comprises at least one energy storing unit, which comprises a third electrical input connector, at least one battery module and a third electrical output connector, wherein the at least one energy storing unit is arranged for receiving power from the charger unit via the third electrical input connector, and further arranged for storing the power in the at least one battery module and further arranged for transferring the stored power to a battery for an electrically powered mining, constructions, or excavation vehicle, via the third electrical output connector, wherein each energy storing unit comprises at least one third mating side which third mating side is arranged to mate to a mating side of at least one charger unit, such that, when positioned side by side, the at least one energy storing unit and the at least one charger unit form a single, spatially confined unit.

11. The DC-charging system according to claim 10, wherein the energy storing unit comprises a plurality of battery modules which forms a battery sub-pack.

12. The DC-charging system according to claim 11, wherein the energy storing unit comprises a plurality of battery sub-packs which forms a battery pack.
